(19) United States
(12) Patent Application Publication
(10) Pub. No.: US 2008/0119083 A1
(43) Pub. Date: May 22, 2008

(54) PLUG-IN MODULE

(75) Inventor: Michael LENDI, Mels (CH)

Correspondence Address: BURR & BROWN, PO BOX 7068, SYRACUSE, NY, 13261-7068, US

(73) Assignee: Cedes AG, Landquart (CH)

(21) Appl. No.: 11/942,995

(22) Filed: Nov. 20, 2007

(30) Foreign Application Priority Data
Nov. 22, 2006 (DE) 20 2006 017 882.1

(51) Int. Cl. H01R 35/00

(52) U.S. Cl. 439/534

(57) ABSTRACT

A plug-in module for mounting on a mounting device is provided, the plug-in module including a housing with a rear mounting face and plug regions on the front face. At least one additional plug region is formed between the front face and the rear mounting face on the housing.

This application claims the benefit under 35 USC 119(a)-(d) of German Application No. 20 2006 017 882.1 filed Nov. 22, 2006, the entirety of which is incorporated herein by reference.

### FIELD OF THE INVENTION

The invention relates to a plug-in module for mounting on a mounting device.

### BACKGROUND OF THE INVENTION

Various embodiments of plug-in modules, in particular plug-in modules in the form of electronic control modules, are already known.

The plug-in control modules are routinely configured such that they can be attached to a standardized mounting rail in a standardized electrical cabinet. Mounting on a top-hat rail (for example DIN top-hat rail 35 mm according to EN 50022) is used by way of example.

Plug-in control modules of this type normally have a significantly greater height than width in relation to a transversely running rail. A large number of plug-in control modules are routinely attached next to one another along the rail.

In some embodiments, snap-action means are provided on the lateral boundary walls, on which another plug-in module is arranged in a row, in order to mechanically connect the plug-in modules which are arranged next to one another.

At least one plug region for inserting one or more plugs is normally provided on the front face of such a plug-in control module. However, the number of plug spaces on the front face of a control module has heretofore been limited.

### SUMMARY OF THE INVENTION

The present invention is based on the object of providing a plug-in module of the type mentioned in the introduction which has an extended use area in terms of plug regions.

The invention proceeds from a plug-in module, in particular an electronic plug-in control module. The module is, for example, a control module for a safety device such as a light curtain or the like. The plug-in module can be fitted to a mounting device, for example mounted on a mounting rail on a standardized mounting rail in a standard electrical cabinet. The plug-in module has a housing which comprises a rear mounting face and also at least one plug region on a front face. The core concept of the invention is that at least one additional plug region is formed between the front face and the rear mounting face on the housing. By means of this measure, more plugs can be placed on the plug module in total. Therefore, various plug-in options can be provided, and this permits a flexible wide range of use of such plug-in modules when insertion space is limited.

The front faces of plug-in modules do not necessarily have to be flat. The front face may include stepped areas, curved regions and/or beveled areas.

In a preferred embodiment of the present invention, the at least one additional plug region is formed in a surface of the housing defined by an undercut portion in relation to the front face. Additional surfaces are created by the undercut, in order to be able to arrange plugs. In this case, the plug-in module is preferably configured such that cables are routed to the plug spaces on a face which extends transverse to the planar side regions on which further plug-in modules are arranged in a row relative to one another in each case.

In the case of a housing having an elongate front face and faces adjoining the front face, the undercuts are preferably provided on these typically narrow adjoining faces, possibly over the full width of the plug-in module.

In order to be able to create further plug regions, a plurality of undercuts are preferably provided.

In a preferred embodiment of the present invention, the at least one plug region is arranged in a surface of the undercut which faces towards the front face. Therefore, plugs for a plug region of this type can be oriented in the same way as on the front face of the plug-in module. This saves space for routing the cable in a bent manner.

In a further particularly preferred embodiment of the present invention, two preferably symmetrically arranged undercuts are provided on opposite faces of the housing which run transverse to planar side regions on which the plug-in modules are arranged in a row relative to one another. These are opposite narrow faces in the case of an elongate front face transverse to the direction of arrangement in a row.

In order to further increase the plug options, it is further proposed that a plurality of undercuts which are situated one behind the other, as seen from the front face, are provided. It is also feasible here, in the case of a housing piece between two undercuts, to route the cable past laterally, that is to say on a face on which another plug-in module can be arranged in a row, to an undercut which is situated behind said two undercuts and is intended for a plug for insertion into a plug region. To this end, a corresponding cutout can be provided in order to prevent lateral wear of the cable.

It is also advantageous to provide fixing means for securing a cable of a plug for a plug-in region on a face of the housing which runs transverse to planar side regions. For example, web means can be arranged, possibly in a labyrinthine manner, on a corresponding face in order to be able to relieve the strain on the cable by means of the cable being routed in a crossed-over manner.

In order to further increase the insertion options on the plug-in module, it is also advantageous to provide at least one plug region in the rear mounting face of the housing.

### BRIEF DESCRIPTION OF THE DRAWINGS

An exemplary embodiment of the invention is explained in greater detail with reference to the following drawing Figures, with further details of the advantages being specified.

FIG. 1 shows a perspective view of an electronic plug-in control module according to one embodiment of the present invention; and

FIG. 2 is a view of an electronic plug-in control module according to another embodiment of the present invention as seen facing a longitudinal face 24a thereof.

### DETAILED DESCRIPTION OF THE INVENTION

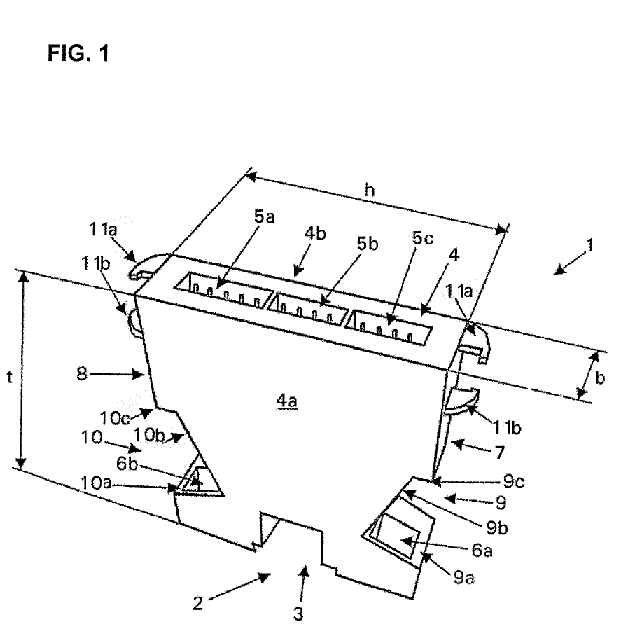

FIG. 1 illustrates an electronic plug-in control module to be attached to a top-hat rail (not depicted). To this end, a suitable recess 3 is formed on a rear mounting face 2 (e.g., a bottom face as shown).

A front face 4 (e.g., a top face as shown) of the plug-in module housing 1 has an elongate configuration, with the longitudinal faces 4a, 4b representing the faces on which further plug-in modules can be arranged in a row. The space on the front face 4 for arranging plug regions 5a, 5b, 5c is limited since both the insertion width b and also the insertion height h are limited in standardized plug-in modules.

In order to be able to provide further plug regions 6a, 6b, undercuts 9, are provided on faces 7, 8, which are faces adjoining the front face 4, over the depth t of the plug-in module housing 1. In the exemplary embodiment, the undercuts 9, 10 each substantially have three surfaces, shown here as 9a, 9b, 9c and 10a, 10b, 10c, respectively. In principle, it is feasible to provide one or more plug regions on each of these surfaces. It is also possible to make the geometric shape of the undercut considerably more complex, so that a larger boundary surface of the undercut with further options for attaching plug regions is produced overall.

However, in the present exemplary embodiment, a plug socket, for example an RJ 45 plug socket in this case, is arranged only on the boundary surfaces 9a, 10a of the undercuts 9 and 10, which are tilted to some extent toward the rear in relation to the front face 4 and which face the front face 4.

In order to be able to reach the respective plug regions 6a, 6b, a cable can be routed along the respective faces 7, 8.

Retaining lugs 11a, 11b are provided on the respective faces 7, 8 of the housing in order to fix and relieve the strain on a corresponding cable. The retaining lugs 11a, 11b are positioned in an offset manner one behind the other in the longitudinal direction of the respective faces 7, 8 and, over the width b of faces 7, 8, are spaced apart from one another in such a way that an inserted cable has to assume a crossed-over course, as a result of which clamping is established.

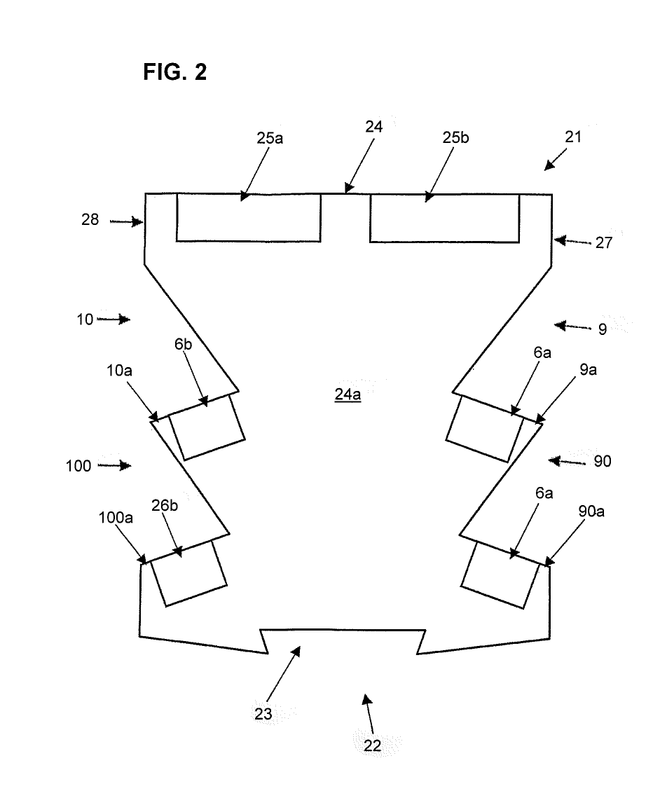

FIG. 2 shows a view of an electronic plug-in control module housing 21 according to another embodiment of the present invention. In this example, the housing includes a front face 24 (e.g., a top face as shown), having plug regions 25a and 25b arranged therein. A recess 23 is formed on a rear mounting face 22 (e.g., a bottom face as shown) in a similar manner as shown and described in connection with FIG. 1.

The face 28 adjoining the front face 24 of the housing includes two undercut portions 10 and 100, each having a plurality of surfaces. A plug region 6b is provided on a surface 10a of undercut 10 and a plug region 26b is provided on a surface 100a of undercut 100. Similarly, the face 27 adjoining the front face 24 includes two undercut portions 9 and 90, each having a plurality of surfaces, a plug region 6a provided on a surface 9a of undercut 9 and a plug region 26b provided on a surface 90a of undercut 90. As shown, the undercuts 10 and 100 on face 28 are situated behind one another as seen from the front face 24. This type of arrangement is also seen with respect to the undercuts 9 and 90 on face 27.

I claim:

1. A plug-in module for mounting on a mounting device, the plug-in module having a housing comprising a rear mounting face, a front face, at least one first plug region on the front face, and at least one second plug region formed between the front face and the rear mounting face of the housing.

2. The plug-in module as claimed in claim 1, wherein the at least one second plug region is formed in at least one surface of an undercut formed in at least one face of the housing adjoining the front face.

3. The plug-in module as claimed in claim 2, wherein a plurality of undercuts are provided in the at least one face of the housing adjoining the front face.

4. The plug-in module as claimed in claim 2, wherein the at least one second plug region is arranged in a surface of the undercut that faces toward the front face.

5. The plug-in module as claimed in claim 3, wherein at least one of the plurality of undercuts is provided in another face of the housing adjoining the front face and opposing the at least one face adjoining the front face of the housing.

6. The plug-in module as claimed in claim 3, wherein the plurality of undercuts are situated one behind the other as seen from the front face.

7. The plug-in module as claimed in claim 1, further comprising at least a fixing member for securing a cable of a plug for at least the second plug-in region provided on at least one face of the housing adjoining the front face thereof.

8. The plug-in module as claimed in claim 1, further comprising at least one third plug region provided in the rear mounting face.

9. The plug-in module as claimed in claim 5, wherein the at least one undercut in the at least one face adjoining the front face of the housing is arranged symmetrically with respect to the at least one undercut in the another face of the housing adjoining the front face of the housing.

10. The plug-in module as claims in claim 7, comprising at least a pair of fixing members provided on the at least one face adjoining the front face of the housing and arranged in a laterally and vertically spaced apart relation with respect to one another on the at least one face adjoining the front face of the housing.
